(19) United States
(12) Patent Application Publication
(10) Pub. No.: US 2010/0290812 A1
(43) Pub. Date: Nov. 18, 2010

(54) IMAGE FORMING APPARATUS AND IMAGE FORMING METHOD

(75) Inventors: Hiroyuki TAGUCHI, Shizuoka (JP); Isao YAHATA, Shizuoka (JP); Takahiro KAWAGUCHI, Shizuoka (JP); Ken IGUCHI, Shizuoka (JP); Hiroyuki TSUCHIHASHI, Shizuoka (JP); Hiroyuki TAKI, Shizuoka (JP)

Correspondence Address: PATTERSON & SHERIDAN, L.L.P., 3040 POST OAK BOULEVARD, SUITE 1500, HOUSTON, TX, 77056, US

(73) Assignees: Kabushiki Kaisha Toshiba, Tokyo (JP); Toshiba Tec Kabushiki Kaisha, Tokyo (JP)

(21) Appl. No.: 12/779,747

(22) Filed: May 13, 2010

Related U.S. Application Data
(60) Provisional application No. 61/178,368, filed on May 14, 2009.
(60) Provisional application No. 61/242,725, filed on Sep. 15, 2009.

(51) Int. Cl. G03G 15/01; G03G 15/20

(52) U.S. Cl. 399/223; 399/341

(57) ABSTRACT

An image forming apparatus forms a stamp image with a stamp image developer having a color developing temperature at a color erasing temperature of an image forming developer, and forms a mask image with a mask image developer having a color re-developing temperature at a temperature not lower than a color re-developing temperature of the image forming developer. Accordingly, when a confidential document is color-erased, the stamp image develops color, and when the color-erased confidential document again develops color, it can not be read.

### CROSS-REFERENCE TO RELATED APPLICATIONS

This application is based upon and claims the benefit of priority from the prior U.S. Patent Application No. 61/178,368 filed on May 14, 2009, the prior U.S. Patent Application No. 61/242,725 filed on Sep. 15, 2009 and the entire contents of which are incorporated herein by reference.

### TECHNICAL FIELD

The present invention relates to an image forming apparatus capable of keeping security of a recording medium on which an image is formed with color erasable developer, and an image forming method.

### BACKGROUND

In recent years, from the demand for resource saving, an image forming apparatus in which an image is formed with color erasable developer and a color erasing apparatus are introduced. In this color erasing apparatus, heat or light is applied to a recording medium, on which an image is formed with color erasable developer, to erase the color of the developer, and erases the image. Accordingly, the recording medium after the color erase can be re-used.

Here, there arises a problem in handling when an image of a confidential document is formed by the above image forming apparatus. This is because when the color erasable developer is cooled to a very low temperature, color development can again occur. Besides, this is because there is a risk that a readable state occurs even if color development does not again occur.

In this point, an image forming apparatus is proposed in which an image of identification information indicating confidential document is formed on a confidential document, and when the recording medium is reused, when the image forming apparatus detects this identification information, it is used for control of copying.

### SUMMARY

It is an object of the present invention to provide an image forming apparatus to improve the security of a recording medium on which an image is formed with color erasable developer, and an image forming method.

In an aspect of the present invention, an image forming apparatus to form an image on a recording medium includes an electrostatic latent image carrier to carry an electrostatic latent image, a developer supply unit to supply an image forming developer to the electrostatic latent image, an image carrier to carry a developer image, a stamp image developer supply unit to supply a stamp image forming developer, a color developing temperature of which is a temperature higher than a fixing temperature of the image forming developer and lower than a color erasing temperature of the image forming developer, to the image carrier, and a fixing unit to fix the developer image, which is transferred from the image carrier to a recording medium, to the recording medium.

### DESCRIPTION OF THE DRAWINGS

FIG. 1 is a diagram showing a structure of an image forming apparatus capable of forming a color image according to the invention.

FIG. 2 is a diagram showing a structure of an image forming apparatus capable of forming a monochrome image according to the invention.

FIG. 3 is a schematic diagram showing a structure of an image forming apparatus according to the invention.

FIG. 4 is a diagram showing a relation of an image forming developer and a stamp image developer to temperature according to the invention.

FIG. 5 is a diagram showing a relation of an image forming developer and a mask image developer to temperature according to the invention.

FIG. 6 is a diagram showing a structure of a color erasing apparatus according to the invention.

FIG. 7 is a schematic diagram showing a structure of the color erasing apparatus according to the invention.

FIG. 8 is a flowchart showing a stamp image forming operation in the image forming apparatus according to the invention.

FIG. 9 is a flowchart showing an operation of the color erasing apparatus according to the invention.

FIG. 10 is a diagram showing a state of image formation of a stamp image and a state of color development.

FIG. 11 is a diagram showing a state of image formation of a mask image and a state of color development.

### DETAILED DESCRIPTION

Throughout this description, the embodiments and examples shown should be considered as exemplars, rather than limitations on the apparatus and methods of the present invention.

Hereinafter, an image forming apparatus and an image forming method of an embodiment of the invention will be described in detail with reference to the drawings. Here, the image forming apparatus includes a copying machine, an MFP (Multifunction Peripheral) and a printer.

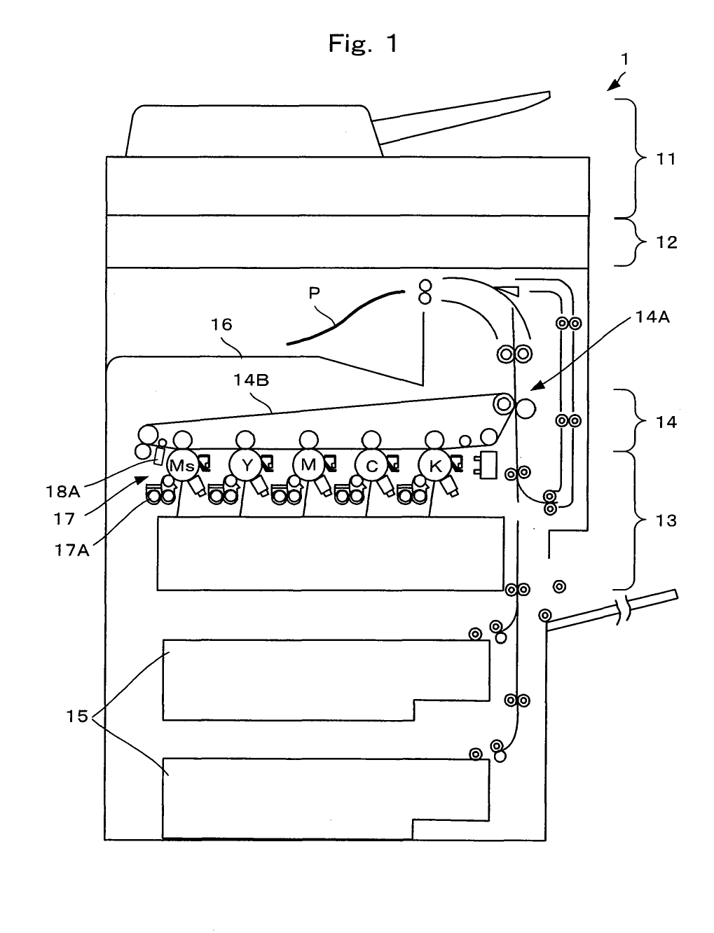

FIG. 1 is a diagram showing a structure of an image forming apparatus 1 capable of forming a color image according to this embodiment. As shown in FIG. 1, the image forming apparatus 1 includes an auto document feeder 11, an image reading portion 12, an image forming portion 13, a transfer portion 14, a sheet conveyance device and a paper feed unit 15.

The auto document feeder 11 is openably and closably provided at an upper part of a main body of the image forming apparatus 1. The auto document feeder 11 includes a document conveyance device to take out documents one by one from a paper feed tray and convey them to a storage tray.

The auto document feeder 11 conveys documents one by one to a document reading portion of the image reading portion 12 by a document conveyance device. Besides, the auto document feeder 11 is opened and a document can be placed on a document table of the image reading portion 12.

The image reading portion 12 includes a carriage provided with an exposure lamp to expose a document and a first reflecting mirror, plural second reflecting mirrors provided on a main body frame of the image forming apparatus 1, a lens block, and a CCD (Charge Coupled Device) of an image reading sensor.

The carriage rests in the document reading portion or reciprocates under the document table, and causes the first reflecting mirror to reflect the light of the exposure lamp reflected by the document. The plural second reflecting mirrors reflect the reflected light of the first reflecting mirror to the lens block. The lens block varies the reflected light and outputs it to the CCD. The CCD converts the incident light into an electric signal, and outputs it as an image signal to the image forming portion 13.

The image forming portion 13 includes a laser irradiation unit, a photoconductive drum as an electrostatic latent image carrier and a developer supply unit for each of yellow Y, magenta M, cyan C, black K and after-mentioned mask image Ms.

A mask image developer supply unit 17A supplies a mask image developer to an electrostatic latent image of a mask image on a mask image photoconductive drum Ms. The mask image developer supply unit 17A and the mask image photoconductive drum Ms are called a mask image forming portion 17.

Besides, the image forming portion 13 includes a stamp device 18A as a stamp image developer supply unit. The stamp device 18A uses a developer to form a previously determined image, for example, “confidential document” on a transfer belt 14B.

The laser irradiation unit irradiates a laser beam to the photoconductive drum based on the image signal and forms the electrostatic latent image on the photoconductive drum. The developer supply unit supplies the developer to the photoconductive drum, and forms a developer image from the electrostatic latent image.

The paper feed unit 15 takes out recording media one by one from a paper feed cassette and delivers them to the sheet conveyance device. The sheet conveyance device conveys the recording medium to the transfer portion 14.

The transfer portion 14 includes a transfer belt 14B, a transfer roller and a fixing device 14A. The transfer belt 14B as the image carrier receives the developer image of the photoconductive drum and carries it. The transfer roller applies a voltage and transfers the developer image of the transfer belt to the conveyed recording medium. The fixing device 14A heats and pressurizes the developer image and fixes it to the recording medium.

The recording medium P discharged from a paper discharge port is stacked on the storage tray 16 as a supporting portion for supporting recording media.

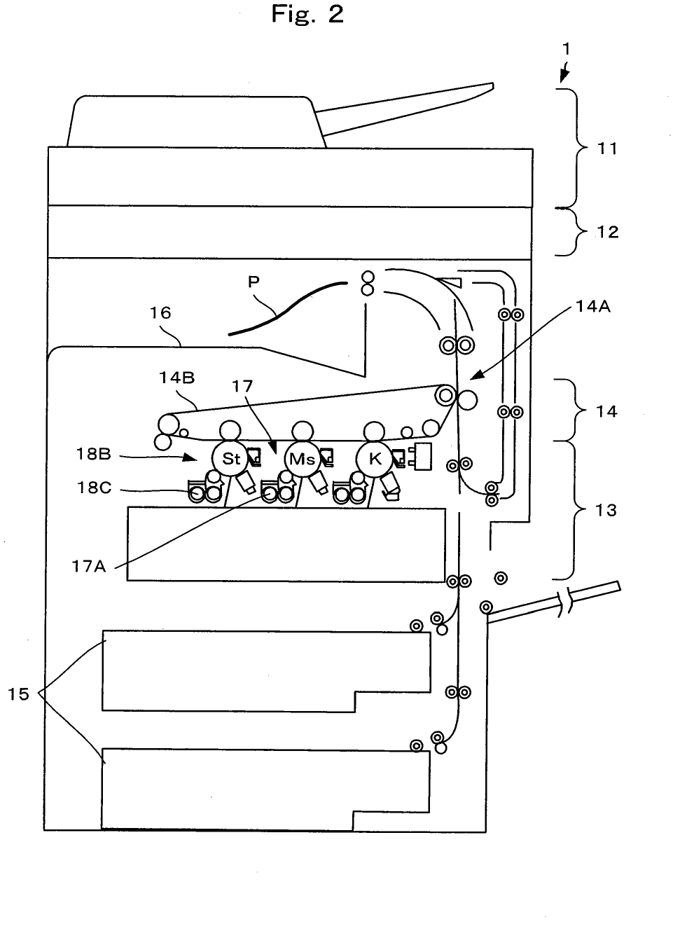

FIG. 2 is a diagram showing a structure of an image forming apparatus 1 capable of forming a monochrome image according to this embodiment. As shown in FIG. 2, the image forming apparatus 1 includes an auto document feeder 11, an image reading portion 12, an image forming portion 13, a transfer portion 14, a sheet conveyance device and a paper feed unit 15.

The auto document feeder 11 is openably and closably provided at an upper part of a main body of the image forming apparatus 1. The auto document feeder 11 includes a document conveyance device to take out documents one by one from a paper feed tray and convey them to a storage tray.

The auto document feeder 11 conveys the documents one by one to a document reading portion of the image reading portion 12 by a document conveyance device. Besides, the auto document feeder 11 is opened and a document can be placed on a document table of the image reading portion 12.

The image reading portion 12 includes a carriage provided with an exposure lamp to expose a document and a first reflecting mirror, plural second reflecting mirrors provided on a main body frame of the image forming apparatus 1, a lens block, and a CCD (Charge Coupled Device) of an image reading sensor.

The carriage rests in the document reading portion or reciprocates under the document table, and causes the first reflecting mirror to reflect the light of the exposure lamp reflected by the document. The plural second reflecting mirrors reflect the reflected light of the first reflecting mirror to the lens block. The lens block varies the reflected light and outputs it to the CCD. The CCD converts the incident light into an electric signal, and outputs it as an image signal to the image forming portion 13.

The image forming portion 13 includes a laser irradiation unit, a photoconductive drum as an electrostatic latent image carrier and a developer supply unit for each of black K, an after-mentioned mask image Ms and an after-mentioned stamp image St.

A mask image developer supply unit 17A supplies a mask image developer to an electrostatic latent image on a mask image photoconductive drum Ms. The mask image developer supply unit 17A and the mask image photoconductive drum Ms are called a mask image forming portion 17.

A stamp image developer supply unit 18C supplies a stamp image developer to an electrostatic latent image on a stamp image photoconductive drum St. The stamp image developer supply unit 18C and the stamp image photoconductive drum St are called a stamp image forming portion 18.

The laser irradiation unit irradiates a laser beam to the photoconductive drum based on the image signal and forms the electrostatic latent image on the photoconductive drum. The developer supply unit supplies the developer to the photoconductive drum, and forms a developer image from the electrostatic latent image.

The paper feed unit 15 takes out recording media one by one from a paper feed cassette and delivers, them to the sheet conveyance device. The sheet conveyance device conveys the recording medium to the transfer portion 14.

The transfer portion 14 includes a transfer belt 14B, a transfer roller and a fixing device 14A. The transfer belt 14B as the image carrier receives the developer image of the photoconductive drum and carries it. The transfer roller applies a voltage and transfers the developer image of the transfer belt to the conveyed recording medium. The fixing device 14A heats and pressurizes the developer image and fixes it to the recording medium.

The recording medium P discharged from a paper discharge port is stacked on the storage tray 16 as a supporting portion for supporting recording media.

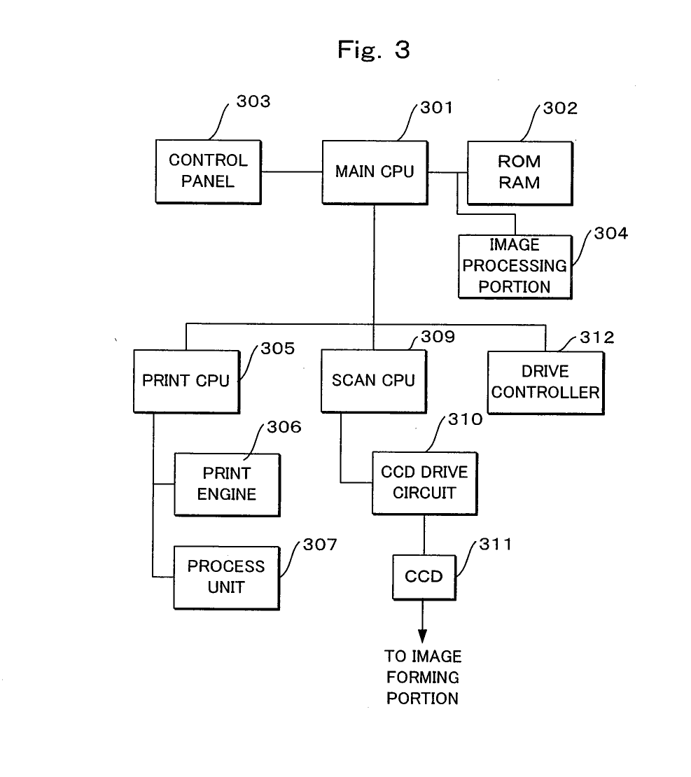

FIG. 3 is a schematic diagram showing a structure of the image forming apparatus 1. As shown in FIG. 3, the image forming apparatus 1 includes a main CPU 301 as a controller to overall control the entire image forming apparatus 1, a control panel 303 connected to the main CPU 301, a ROM, RAM 302 as a storage device, and an image processing portion 304 to perform image processing.

The main CPU 301 is connected to a print CPU 305 to control respective parts of an image forming system, a scan CPU 309 to control respective parts of an image reading system, and a drive controller 312 to control a drive portion.

The print CPU 305 controls a print engine to form an electrostatic latent image on a photoconductive drum, and a process unit 307 to form a developer image.

The scan CPU 309 controls a CCD drive circuit 310 to drive a CCD 311. A signal from the CCD 311 is outputted to the image forming portion 13.

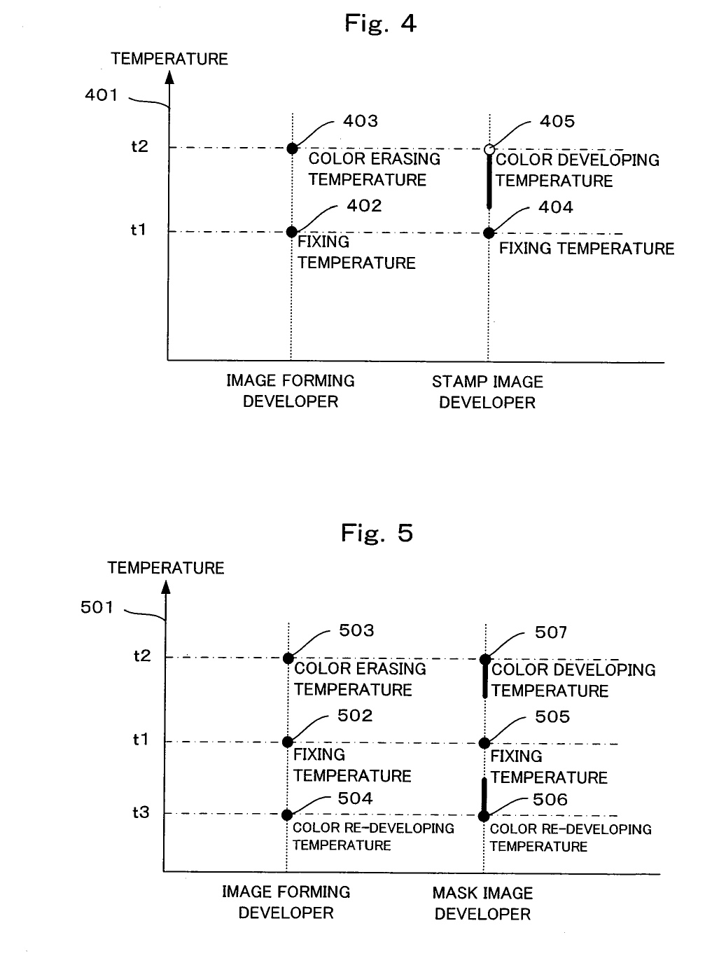

FIG. 4 is a diagram showing a relation of an image forming developer and a stamp image developer to temperature. A vertical axis 401 indicates the temperature. As shown in FIG. 4, it is assumed, that with respect to the image forming developer of yellow Y, magenta M, cyan C and black K, a fixing temperature 402 to a recording medium is a temperature t1, and a color erasing temperature 403 at which the color of the developer is erased is a temperature t2 higher than the temperature t1.

The stamp image developer does not develop color at the time of stamp image formation. With respect to the stamp image developer, a fixing temperature 404 is t1 equal to the fixing temperature 402 of the image forming developer. With respect to the stamp image developer, a color developing temperature 405 at which color is developed is a temperature higher than this fixing temperature 404 and lower than the color erasing temperature 403 of the image forming developer. The stamp image developer develops color at a temperature not lower than the color developing temperature 405.

FIG. 5 is a diagram showing a relation of the image forming developer and the mask image developer to temperature. A vertical axis 501 indicates the temperature. As shown in FIG. 5, with respect to the image forming developer of yellow Y, magenta M, cyan C and black K, it is assumed that a fixing temperature 502 to a recording medium is a temperature t1, a color erasing temperature 503 at which the color of the developer is erased is a temperature t2 higher than the temperature t1, and a color re-developing temperature 504 as a temperature at which the developer, the color of which was once erased, again develops color is a temperature t3 lower than the fixing temperature 502.

The mask image developer does not develop color at the time of image formation of a mask image. With respect to the mask image developer, a fixing temperature 505 is t1 equal to the fixing temperature 502 of the image forming developer. With respect to the mask image developer, a color developing temperature 507 is a temperature higher than the fixing temperature 505 and not higher than the color erasing temperature 503 of the image forming developer. With respect to the mask developer, a color re-developing temperature 506 is lower than the fixing temperature 505 and not lower than the color re-developing temperature 504 of the image forming developer.

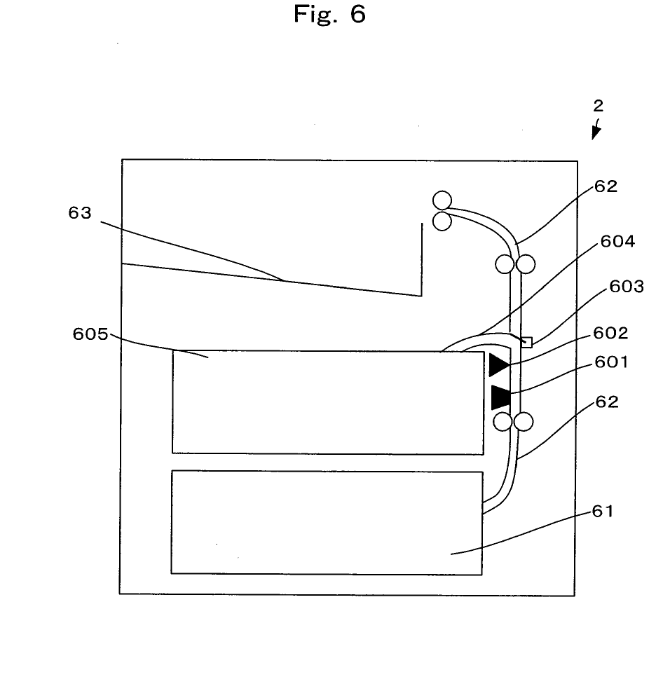

FIG. 6 is a diagram showing a structure of a color erasing apparatus 2. As shown in FIG. 6, the color erasing apparatus 2 includes a recording medium storage portion 61 to store a recording medium on which an image is formed with color erasable developer, a recording medium conveyance device 62 to take out and convey recording media one by one from the recording medium storage portion 61, a storage tray 63 on which a color-erased recording medium is stacked, a collection box 605 to store an un-reusable recording medium, and a recording medium conveyance path 604 to the collection box.

Besides, the color erasing apparatus 2 includes a thermal head 601 as a heating device disposed at a middle of the recording medium conveyance device 62, a scanner 602 as an image reading device disposed downstream of the thermal head 601 in a recording medium conveyance direction, and a switching device 603 which is disposed downstream of the scanner 602 in the recording medium conveyance direction and selectively switches the direction of a conveyance path of the recording medium between a direction toward the storage tray 63 and a direction toward the collection box 605.

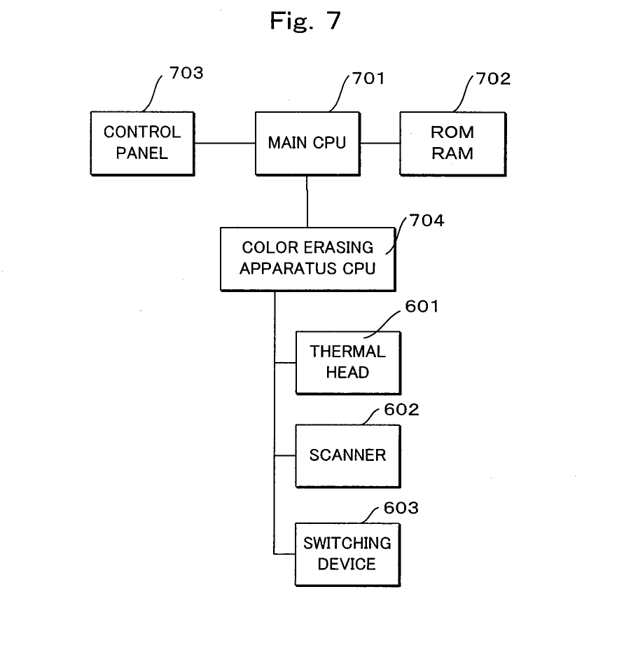

FIG. 7 is a schematic diagram showing a structure of-the color erasing apparatus 2. AS shown in FIG. 7, the color erasing apparatus 2 includes a main CPU 701 as a controller to overall control the entire color erasing apparatus 2, a control panel 703 connected to the main CPU 701, and a ROM, RAM 702 as a storage device.

The main CPU 701 is connected to a color erasing apparatus CPU 704 to control the thermal head 601. The color erasing apparatus CPU 704 is connected to the scanner 602, the thermal head 601 and the switching device 603 which are installed in the color erasing apparatus 2.

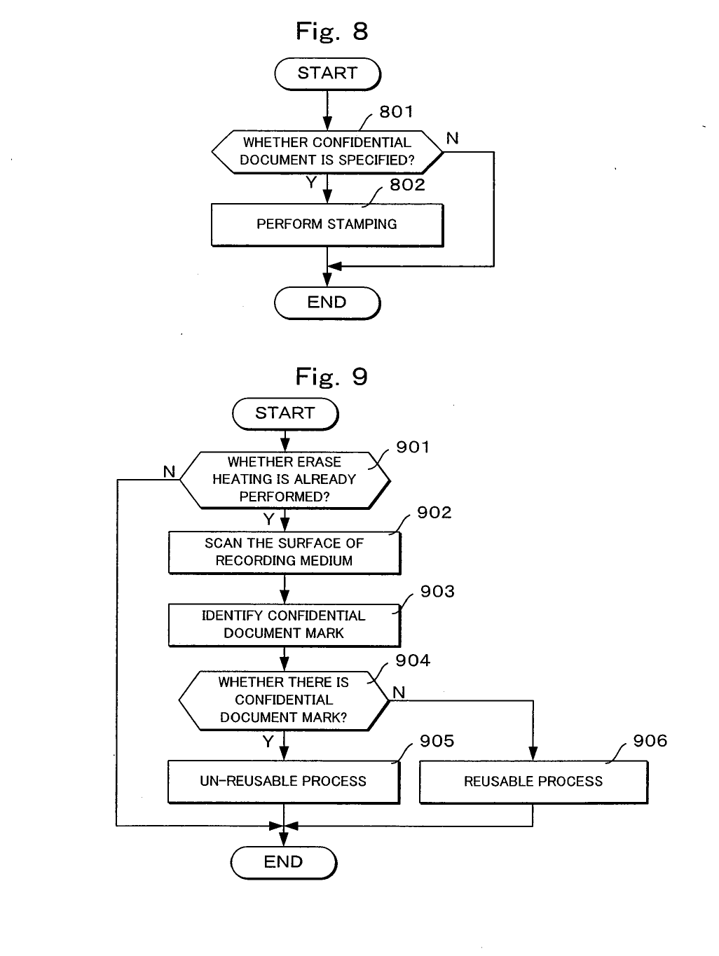

FIG. 8 is a flowchart showing a stamp image forming operation of the image forming apparatus 1. As shown in FIG. 8, at Act 801, the image forming apparatus 1 determines whether a designation indicating confidential document is inputted from the control panel. When the designation indicating confidential document is inputted from the control panel, the image forming apparatus 1 advances to Act 802, and when not inputted, the procedure is ended.

At Act 802, the image forming apparatus 1 forms a stamp image.

Here, a mask image will be described. The mask image is a solidly shaded print or a pattern in which a character can not be read when it overlaps the character. The mask image is formed only in the range of the confidential document or on the whole surface of the recording medium. The range of the confidential document can be designated through the control panel 303. The mask image may be formed on all recording media, or may be formed only when the designation indicating confidential document is inputted from the control panel.

When the mask image is formed on the whole surface, the stamp image is formed in a range not overlapping the mask image.

FIG. 9 is a flowchart showing an operation of the color erasing apparatus 2. As shown in FIG. 9, at Act 901, it is determined whether the color erasing apparatus 2 performs color erase heating, which is heating for color erasing, to the recording medium. When the color erasing apparatus 2 performs the color erase heating, advance is made to Act 902, and when not, the procedure is ended.

Here, although the stamp image developer does not develop color at the time of fixing to the recording medium, it develops color when heated at a temperature lower than the color erasing temperature 403 of the image forming developer. That is, when heating is performed by the color erasing apparatus 2 for color erasing, the stamp image develops color and can be visually recognized.

At Act 902, the color erasing apparatus 2 scans the surface of the recording medium by the scanner 602.

At Act 903, the color erasing apparatus 2 identifies the image read by the scanner 602.

At Act 904, the color erasing apparatus 2 determines whether a confidential document mark as the stamp image exists in the identified image. When the confidential document mark exists in the identified image, the color erasing apparatus 2 advances to Act 905, and when not, advance is made to Act 906.

At Act 905, the color erasing apparatus 2 performs an un-reusable process. For example, the color erasing apparatus 2 switches the switching device 603 to the direction toward the collection box 605, and collects the recording medium having the confidential document mark into the collection box 605.

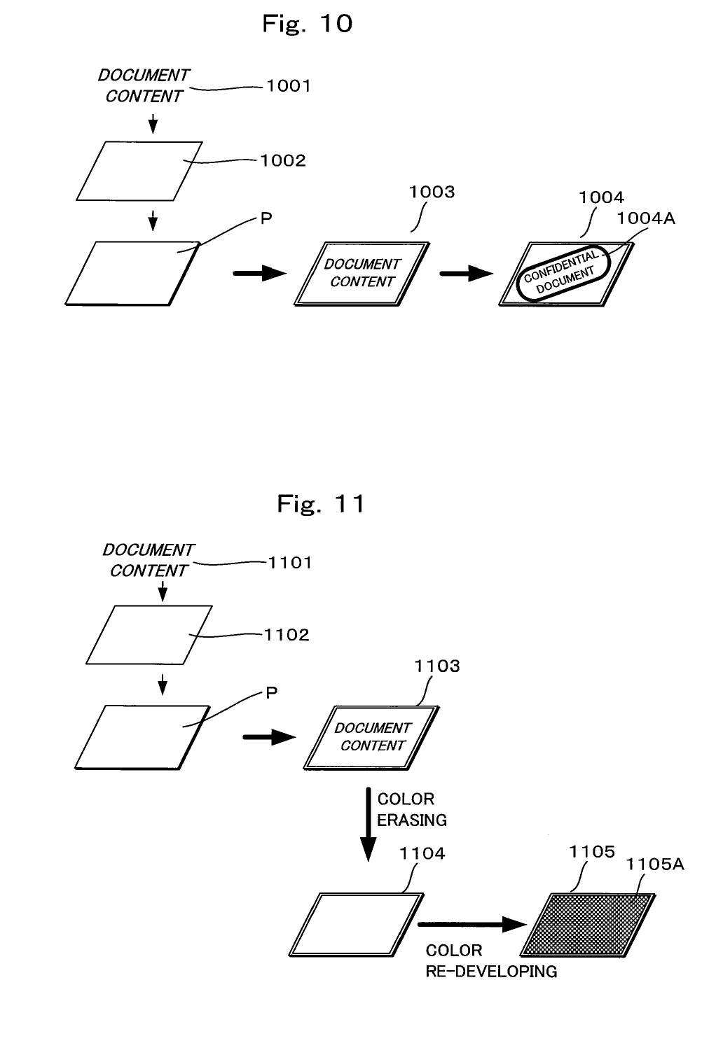

FIG. 10 is a diagram showing a state of image formation of a stamp image and a state of color development. As shown in FIG. 10, a stamp image 1002 is first formed on a recording medium P with a stamp image developer in a state where color development does not occur, and further, an image of a document content 1001 is formed with an image forming developer.

When a recording medium 1003 on which the image was formed is color-erased by the color erasing apparatus 2, as in a state 1004 after the color erasing, a “confidential document” stamp 1004A as the stamp image develops color. Accordingly, the stamp image can be visually recognized, and can be scanned by the scanner 602.

FIG. 11 is a diagram showing a state of image formation of a mask image and a state of color development. As shown in FIG. 11, a mask image 1102 is formed on a recording medium P with a mask image developer in a state where color development does not occur, and further, an image of a document content 1101 is formed with an image forming developer.

When the recording medium P on which the image was formed is heated and is color-erased, the document content is color-erased (1104). In this state, when the recording medium is cooled to a color re-developing temperature (1105), although the document content again develops color, a mask image 1105A also develops color. Accordingly, the document content can not be read.

As described above, in the image forming apparatus 1, the color erasing apparatus 2 and the security keeping method according to the embodiment, the image forming apparatus 1 forms the stamp image with the stamp image developer having the color developing temperature 405 at the color erasing temperature 403 of the image forming developer, and forms the mask image with the mask image developer having the color re-developing temperature 506 at a temperature not lower than the color re-developing temperature 504 of the image forming developer.

Accordingly, when the confidential document is color-erased, the stamp image develops color, and when the color-erased confidential document again develops color, it can not be read, and there is an effect that the security can be efficiently kept.

While certain embodiments have been described, these embodiments have been presented by way of example only, and are not intended to limit the scope of the inventions. Indeed, the novel methods and apparatuses described herein may be embodied in a variety of other forms; furthermore, various omissions, substitutions and changes in the form of the methods and systems described herein may be made without departing from the spirit of the inventions. The accompanying claims and their equivalents are indeed to cover such forms or modifications as would fall within the scope and spirit of the inventions.

What is claimed is:

1. An image forming apparatus to form an image on a recording medium, comprising:
an electrostatic latent image carrier to carry an electrostatic latent image;
a developer supply unit to supply an image forming developer to the electrostatic latent image;
an image carrier to carry a developer image;
a stamp image developer supply unit to supply a stamp image developer, a color developing temperature of which is a temperature higher than a fixing temperature of the image forming developer and lower than a color erasing temperature of the image forming developer, to the image carrier, and
a fixing unit to fix the developer image, which is transferred from the image carrier to a recording medium, to the recording medium.

2. The apparatus of claim 1, wherein the stamp image developer supply unit is a stamp device to supply the stamp image developer to the image carrier.

3. The apparatus of claim 1, wherein the stamp image developer supply unit supplies the stamp image developer to the electrostatic latent image carrier.

4. The apparatus of claim 1, further comprising
a mask image developer supply unit to supply a mask image developer, a color developing temperature of which is higher than the fixing temperature of the image forming developer and not higher than the color erasing temperature of the image forming developer and a color re-developing temperature of which is lower than the fixing temperature of the image forming developer and not lower than a color re-developing temperature of the image forming developer, to the electrostatic latent image of a mask image formed on the electrostatic latent image carrier.

5. The apparatus of claim 4, wherein the mask image is a solidly shaded image.

6. The apparatus of claim 4, wherein the mask image is a pattern in which when it overlaps a document subjected to image formation, the document can not be read.

7. The apparatus of claim 4, wherein the mask image is formed in a range where an image of a document is formed.

8. The apparatus of claim 1, further comprising a color erasing apparatus including:
a recording medium storage portion to store a recording medium on which an image is formed with a color erasable developer;
a recording medium conveyance device to take out the recording medium one by one from the recording medium storage portion and to convey it;
a heating device which is disposed at a middle of a recording medium conveyance path of the recording medium conveyance device and heats the recording medium to erase a color of the color erasable developer; and
a storage tray to stack the color-erased recording medium.

9. The apparatus of claim 8, wherein the color erasing apparatus further includes a scanner which is disposed downstream of the heating device of the recording medium conveyance path in a recording medium conveyance direction and reads the stamp image.

10. The apparatus of claim 9, wherein the color erasing apparatus performs a previously determined operation for an un-reusable recording medium when the scanner detects the stamp image which develops color by heating for color erasing.

11. An image forming method of an image forming apparatus to form an image on a recording medium, comprising:
carrying an electrostatic latent image by an electrostatic latent image carrier;
supplying an image forming developer to the electrostatic latent image by a developer supply unit;
carrying a developer image by an image carrier;
supplying a stamp image developer, a color developing temperature of which is a temperature higher than a fixing temperature of the image forming developer and lower than a color erasing temperature of the image forming developer, to the image carrier by a stamp image developer supply unit; and
fixing the developer image, which is transferred from the image carrier to a recording medium, to the recording medium by a fixing unit.

12. The method of claim 11, wherein the stamp image developer supply unit is a stamp device to supply the stamp image developer to the image carrier.

13. The method of claim 11, wherein the stamp image developer supply unit supplies the stamp image developer to the electrostatic latent image carrier.

14. The method of claim 11, further comprising
supplying a mask image developer, a color developing temperature of which is higher than the fixing temperature of the image forming developer and not higher than the color erasing temperature of the image forming developer and a color re-developing temperature of which is lower than the fixing temperature of the image forming developer and not lower than a color re-developing temperature of the image forming developer, to the electrostatic latent image of a mask image formed on the electrostatic latent image carrier by a mask image developer supply unit.

15. The method of claim 14, wherein the mask image is a solidly shaded. image.

16. The method of claim 14, wherein the mask image is a pattern in which when it overlaps a document subjected to image formation, the document can not be read.

17. The method of claim 14, wherein the mask image is formed in a range where an image of a document is formed.

18. The method of claim 11, further comprising:
storing a recording medium, on which an image is formed with a color erasable developer, by a recording medium storage portion of a color erasing apparatus;
taking out and conveying the recording medium one by one from the recording medium storage portion by a recording medium conveyance device;
heating the recording medium to erase color of the color erasable developer by a heating device; and
stacking the color-erased recording medium on a storage tray.

19. The method of claim 18, wherein a scanner of the color erasing apparatus is disposed downstream of the heating device of the recording medium conveyance path in a recording medium conveyance direction and reads the stamp image.

20. The method of claim 19, wherein the color erasing apparatus performs a previously determined operation for an un-reusable recording medium when the scanner detects the stamp image which develops color by heating for color erasing.
